(19) United States
(12) Patent Application Publication
(10) Pub. No.: US 2024/0031950 A1
(43) Pub. Date: Jan. 25, 2024

(54) POWER HEADROOM REPORT TRIGGER FOR SIMULTANEOUS MULTI-PANEL TRANSMISSION

(71) Applicant: Apple Inc., Cupertino, CA (US)

(72) Inventors: Seyed Ali Akbar Fakoorian, San Diego, CA (US); Hong He, San Jose, CA (US); Yushu Zhang, Beijing (CN); Haitong Sun, Cupertino, CA (US); Wei Zeng, Saratoga, CA (US); Chunhai Yao, Beijing (CN); Chunxuan Ye, San Diego, CA (US); Dawei Zhang, Saratoga, CA (US)

(73) Assignee: Apple Inc., Cupertino, CA (US)

(21) Appl. No.: 18/219,010

(22) Filed: Jul. 6, 2023

Related U.S. Application Data
(60) Provisional application No. 63/391,665, filed on Jul. 22, 2022.

(51) Int. Cl. H04W 52/36; H04W 52/24; H04W 52/14

(52) U.S. Cl. CPC H04W 52/365; H04W 52/242; H04W 52/146

(57) ABSTRACT

Techniques described here related to a power headroom power headroom report generation trigger. One aspect of the disclosure includes a user equipment (UE) configured to measure a first path loss change of a first physical uplink shared channel (PUSCH) transmission transmitting from the first antenna panel to a first transmission and reception point (TRP). The UE can further measure a second path loss change of a second PUSCH transmission transmitting from the second antenna panel to a second TRP, the second PUSCH transmission transmitting simultaneously to the first PUSCH transmission. The UE can further determine whether to generate a powerhead report (PHR) based on the measured first path loss change and measured second path loss change. The UE can further generate the PHR based on the determination.

### CROSS-REFERENCE TO RELATED APPLICATIONS

This application is claims the benefit of U.S. Provisional Application No. 63/391,665, filed on Jul. 22, 2022, which is incorporated by reference.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of a system for simultaneous multi-panel transmission-based PHR generation, according to one or more embodiments.

FIG. 2 is a process flow for triggering a power headroom (PHR) generation, according to one or more embodiments.

FIG. 3 is a process flow for triggering a PHR generation, according to one or more embodiments.

FIG. 4 is a process flow for triggering a PHR generation, according to one or more embodiments.

FIG. 5 is a process flow for triggering a PHR generation, according to one or more embodiments.

FIG. 6 is a process flow for determining whether a PHR is an actual PHR or a virtual PHR, according to one or more embodiments.

FIG. 7 is a process flow for determining whether a PHR is an actual PHR or a virtual PHR, according to one or more embodiments.

FIG. 8 is a process flow for determining whether a PHR is an actual PHR or a virtual PHR, according to one or more embodiments.

FIG. 9 is a process flow for determining whether a PHR is an actual PHR or a virtual PHR, according to one or more embodiments.

FIG. 10 is a process flow or determining whether a PHR is an actual PHR or a virtual PHR, according to one or more embodiments.

FIG. 11 is an illustration 1100 of a determination of whether a PHR is an actual PHR or a virtual PHR, according to one or more embodiments.

FIG. 12 is a process flow 1200 for powerhead calculation, according to one or more embodiments.

FIG. 13 is a process flow for powerhead calculation, according to one or more embodiments.

FIG. 14 is a process flow for powerhead calculation, according to one or more embodiments.

FIG. 15 illustrates an example of receive components, in accordance with some embodiments.

FIG. 16 illustrates an example of a UE, in accordance with some embodiments.

FIG. 17 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Power headroom provides an indication of the amount of transmission power left for a user equipment (UE) to use in addition to the power being used in the current transmission. The UE can measure power headroom and send a power headroom report (PHR) to a base station using medium access control (MAC) elements that can be transmitted by a physical uplink shared channel (PUSCH) transmission. A network can account for various types of power headroom measurements. For example, in the context of a 3GPP cellular network, Type 1 power headroom is the difference between the nominal UE maximum transmit power and the estimated power for uplink shared channel (UL-SCH) transmission per activated Serving Cell. Type 2 power headroom is the difference between the nominal UE maximum transmit power and the estimated power for UL-SCH and physical uplink control channel (PUCCH) transmission on the primary cell (SpCell) of the other MAC entity. Type 3 power headroom is the difference between the nominal UE maximum transmit power and the estimated power for sounding reference signal (SRS) transmission per activated Serving Cell. In some instances, the PHR is related to the actual power for a channel between the UE and the base station. This can be considered an actual PHR. In other instances, the PHR is based on an estimated power of the channel between the UE and the base station. This can be considered a virtual PHR.

A PHR is configured using a power headroom configuration parameter structure. One parameter is phr-TX-PowerFactorChange, which can be considered a threshold that can be used to trigger the UE to send a PHR to the base station when a path loss has changed by greater than the threshold. The UE can continuously calculate the path loss based on a reference signal power notified by the network and the measured RS power at the UE antenna. If the change in path loss is greater than the phr-TX-PowerFactorChange parameter, the UE can be triggered into generating a PHR to send to the base station. The base station can use PHRs for various reasons, including radio resource management (RRM). One example is the base station can use a PHR to calculate the path loss from the base station to the UE. The base station can use the calculated path loss to enable or disable some functionality of the UE.

Although various mechanisms can trigger the UE to send a PHR to the base station, these mechanisms do not apply to simultaneous uplink (UL) transmissions to multiple transmit and receive points (TRPs). Therefore, if a UE is simultaneously transmitting multiple PUSCH transmissions through multiple antenna panels to multiple TRPs, the UE is not configured to have a trigger for generating a PHR based on the path loss measured at simultaneous beams.

Embodiments of the present disclosure address the above referenced embodiments by providing a methodology for transmitting a PHR based on measurement of simultaneous UL transmissions. The embodiments disclosed herein provide triggering mechanisms directed towards simultaneous UL transmissions through multiple UE antenna panels. Furthermore, the embodiments described here provide a methodology for whether a PHR triggered from a simultaneous UL transmission through multi-panels is an actual PHR or a virtual PHR.

Embodiments of the present disclosure are described in connection with 5G networks. However, the embodiments are not limited as such and similarly apply to other types of communication networks, including other types of cellular networks, such as an LTE network.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

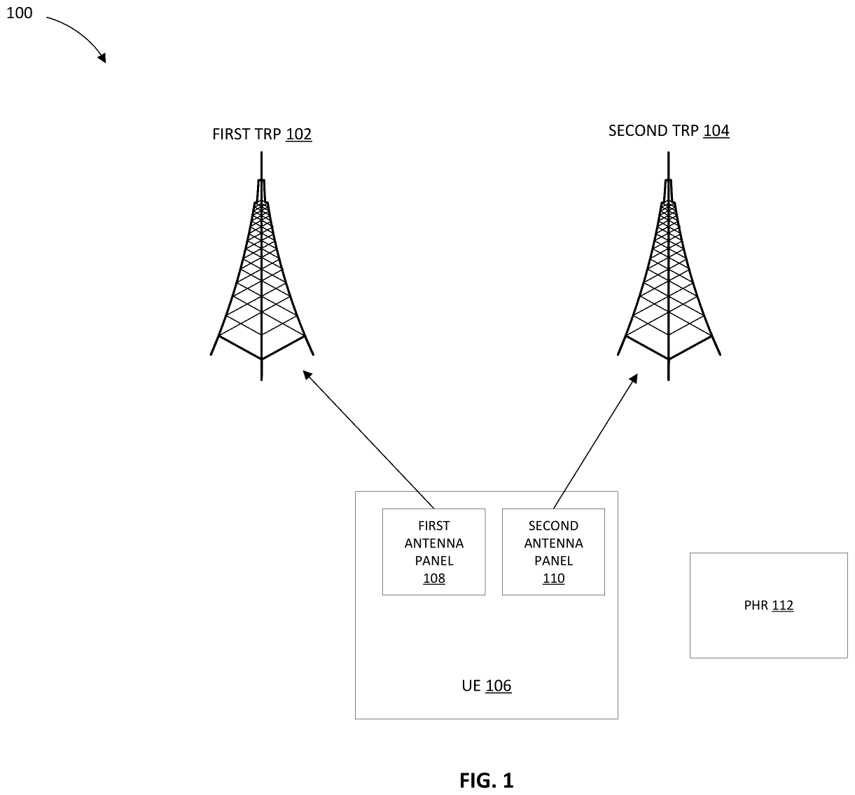

FIG. 1 is an illustration of a system 100 for simultaneous multi-panel transmission-based PHR generation, according to one or more embodiments. The system 100 can include a first transmission and reception point (TRP) 102 and a second TRP 104, where each TRP can be arranged at one or more base stations for providing service to a geographic area (e.g., cell). The TRPs can communicate with the UE 106 through uplink (UL) and downlink (DL) communications. The TRPs can further communicate with each other through backhaul links.

The UE 106 can be located at a fixed position or be movable about inside and outside of the geographic area. The geographic can be, for example, a macro cell that can provide low-frequency coverage over miles, a small cell, including femtocell, picocell, and microcell, that can provide high-frequency coverage for a smaller area. It should be appreciated that although two TRPs are illustrated, in other embodiments, the system 100 can include more than two TRPs. The UE 106 can include a first antenna panel 108 and a second antenna panel 110. The UE 106 can further be configured to simultaneously transmit a first PUSCH transmission through the first antenna panel 108 and a second PUSCH transmission through the second antenna panel 110. In some instances, the first PUSCH transmission and the second PUSCH transmission are received at the either the first TRP 102 or the second TRP 104. In other instances, the first PUSCH transmission is received at the first TRP 102 and the second PUSCH transmission is received at the second TRP 104.

The first TRP 102 and the second TRP 104 and the UE 106 can communicate with each other using component carriers (CCs). A CC includes multiple carriers that are used by a base station to configure the UE 106 for carrier aggregation (CA). The UE 106 can be configured with multiple UL CCs and DL CCs to be used for UL and DL transmissions.

The UE 106 can further be configured to measure a path loss associated with the first PUSCH transmission and the second PUSCH transmission. If the UE 106 returns certain measurements of the simultaneous PUSCH transmissions, the UE 106 can generate a PHR to send to a base station. The UE's triggering mechanisms, determination of whether a PHR is an actual PHR or a virtual PHR, and calculation of the powerhead are described below.

As described herein determining a path loss change can include determining the difference of a path loss, PL₀, at a first time, T₀, and a second path loss, PL₁, as second time, T₁, wherein the second time, T₁ is subsequent to the first time T₀. In some instances, the path loss change can be a positive change (e.g., PL₀>PL₁). In other instances, the path loss change can be a negative change (e.g.., PL₀<PL₁). Yet, even other instances, the path loss change can be zero (e.g., PL₀=PL₁).

In some instances, the triggering mechanism for generating a PHR can be that the transmission power left for the UE 106 to use in addition to the power being used in the current transmission for first PUSCH transmission or the second PUSCH transmission is greater than a threshold. For example, the UE can determine that the transmission power left for either the first PUSCH transmission or the second PUSCH transmission is 5 dB. If the threshold is 4 dB, than the 5 dB transmission power left alone can trigger a PHR. If, however, the threshold power is 5 dB or 6 dB, then the 5 dB transmission power does not trigger a PHR. This threshold can be a different threshold than the disparity threshold and a path loss change threshold described below.

Additionally, the triggering mechanism can be based on a disparity in threshold power left between the first PUSCH transmission and the second PUSCH transmission. If a transmission power disparity between the first PUSCH transmission and the second PUSCH transmission is greater than the power disparity threshold, than the UE 106 can be triggered into generating a PHR. For example, the UE can determine that the transmission power left for the first PUSCH is 6 dB and the transmission power left for the second PUSCH transmission is 3 dB. If the disparity threshold is 2 dB, the UE 106 can be triggered into generating the PHR. If, however, the disparity threshold is 3 dB or greater, than the UE 106 would not be triggered into generating the PHR. This threshold can be a different threshold than the path loss change threshold described below.

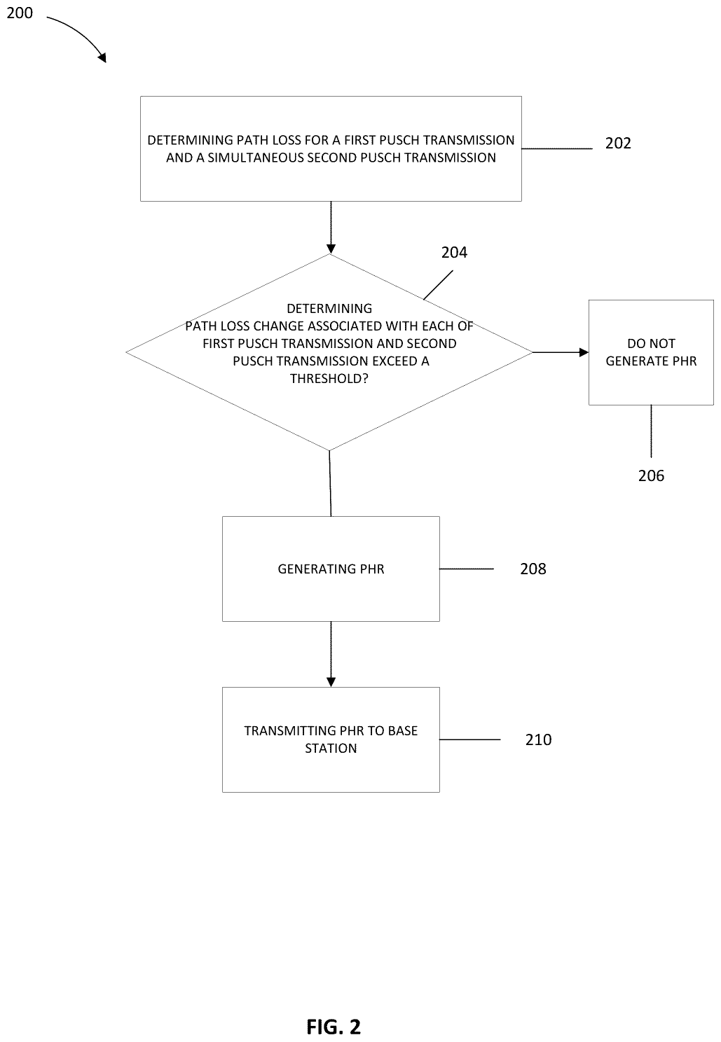

FIG. 2 is a process flow 200 for triggering a PHR generation, according to one or more embodiments. A UE (e.g., UE 106) can be simultaneously transmitting a PUSCH transmission to a first TRP (e.g., TRP 102) through a first antenna panel (e.g., first antenna panel 108) and a second PUSCH transmission to a second TRP (e.g., TRP 104) through a second antenna panel (e.g., second antenna panel 110). At 202, the UE can be determining the path loss change for the first TRP and the second TRP. For example, the UE can calculate the path loss between the first antenna panel and the first TRP based on a reference signal power notified as provided by the network and the measured RS power at the first antenna panel. The UE can repeatedly calculate the path loss for the first TRP and the second TRP such that the UE can compare a current path loss with a previously calculated path loss or store a calculated path loss to compare with a future path loss. The UE can also calculate the path loss between the second antenna panel and the second TRP based on a reference signal power notified as provided by the network and the measured RS power at the first antenna panel.

At 204, the UE can be determining whether the path loss change associated with each of the first TRP and the second TRP exceed a threshold. The threshold value can be indicated to the UE by the base station. For example, the threshold value can by the phr-TX-PowerFactorChange parameter. The calculated path loss change can be a positive change or a negative change in the path loss for the purposes of comparison. In particular, the absolute value of the path loss is considered for the purposes of comparison. For example, the path loss can be +3 db or −3 dB for the first TRP as both have the same absolute value. If the threshold is 2 dB, then the path loss of the first TRP (e.g., +3 dB or −3 dB) is greater than the threshold value. If, however, the threshold is 4 dB, the path loss associated with the first TRP does not exceed the threshold value. In this example, the UE would still need to calculate the path loss change for the second TRP to be triggered into generating a PHR. For example, if the path loss change associated with the second TRP is either +4 dB or −4 dB, and the threshold is 4 dB, the path loss change does not trigger the UE to generate a PHR. This is because, even if the path loss change associated with the TRP exceeded the threshold, the path loss change associated with the second TRP did not exceed the threshold value. Rather the path loss change was the same as the threshold. If, however, the threshold was 3 dB, then the path loss change for the TRP does exceed the threshold (e.g., +4 db>+3 db, |−4 dB|>+3 dB). Furthermore, if the path loss associated with the first TRP also exceeded the threshold, the UE can be triggered to generate PHR.

Alternatively, a path loss change that can trigger the UE to generate a PHR can be the sum of an absolute value of the path loss change for the first TRP and the path loss change for the second TRP. For example, the path loss change for the first TRP is +3 dB and the path loss change for the second TRP is −2 DB, the sum of the absolute values is +5 dB. Therefore, if the threshold is 4 dB then the UE can be triggered to generate a PHR. If, however, the threshold is 6 dB, the UE does not generate a PHR.

If the path loss change associated with each of the first TRP and the second TRP does not exceed the threshold, the UE does not generate a PHR at 206. If, however, the path loss change associated with each of the first TRP and the second TRP does exceed the threshold, the UE does generate a PHR at 208. The PHR can be configured based on a configuration parameter structure. The PHR can further include various parameters, such as phr-PeriodicTimer, phr-ProhibitTimer, phr-TX-PowerFactorChange, multiplePHR, pr-Type2OtherCell, and phr-ModeOtherCG. At 210, the UE can be transmitting the PHR to the base station.

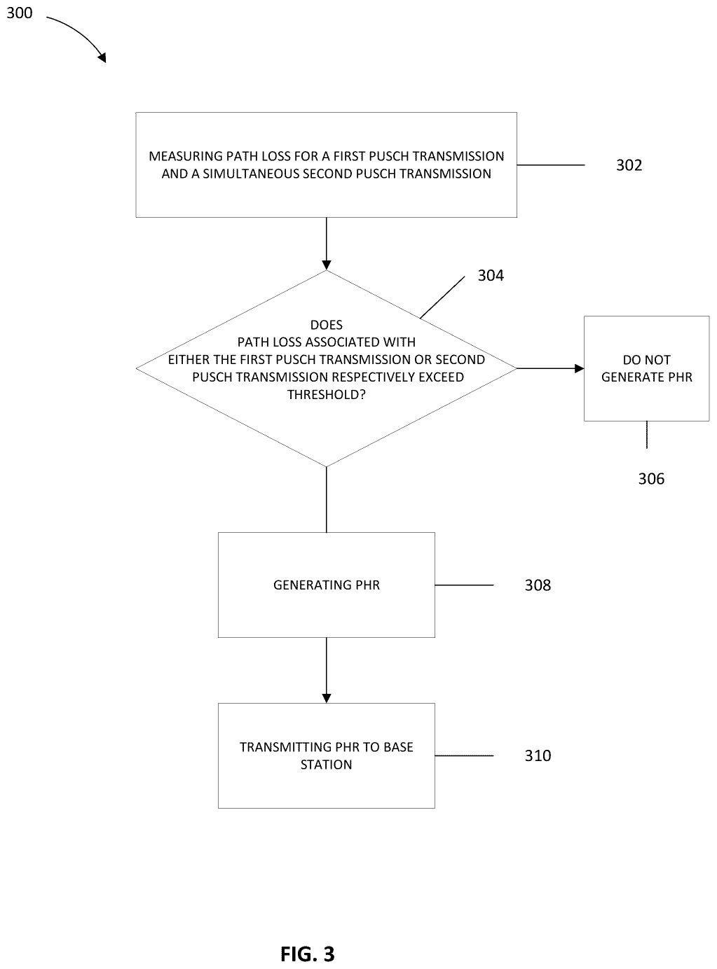

FIG. 3 is a process flow 300 for triggering a PHR generation, according to one or more embodiments. A UE (e.g., UE 106) can be simultaneously transmitting a PUSCH transmission to a first TRP (e.g., TRP 102) through a first antenna panel (e.g., first antenna 108) and a second PUSCH transmission to a second TRP (e.g., TRP 104) through a second antenna panel (e.g., second antenna panel 110) At 302, the UE can be determining the path loss change for the first TRP and the second TRP.

At 304, the UE can be determining whether the path loss change associated with either of the first TRP and the second TRP exceed a threshold. In some instances, this threshold can be the phr-TX-PowerFactorChange parameter as defined in T.S. 38.321 in clause 5.4.6. For example, consider a situation in which the threshold can be 3 dB. If the absolute value of the path loss change for either the first TRP or the second TRP is 4 db (e.g., +4 dB or |−4 dB|) or higher, the UE can be triggered to generate a PHR. If, however, the absolute value of the path loss change for either the first TRP or the second TRP is 3 db (e.g., +3 dB or |−3 dB|) or lower, the UE does not generate a PHR.

Alternatively, base station can configure the UE to use a threshold that is smaller or larger than a threshold (e.g., phr-TX-PowerFactorChange parameter) defined for multi-panel simultaneous PUSCH transmission to a single TRP. In this instance, the base station can configure the UE to use the threshold through a radio resource control configuration of the UE. For example, if the phr-TX-PowerFactorChange parameter for multi-panel simultaneous PUSCH transmission to a single TRP is 5 dB, the base station can set the threshold at 4 dB and lower or 6 dB and higher through an RRC configuration of the UE. The UE can then compare the path loss change measurement to RRC configured threshold.

If the path loss change associated with either of the TRP and the TRP does not exceed the threshold, the UE does not generate a PHR at 306. If, however, the path loss change associated with either of the first TRP and the second TRP does exceed the threshold, the UE does generate a PHR at 308. At 310, the UE can be transmitting the PHR to the base station.

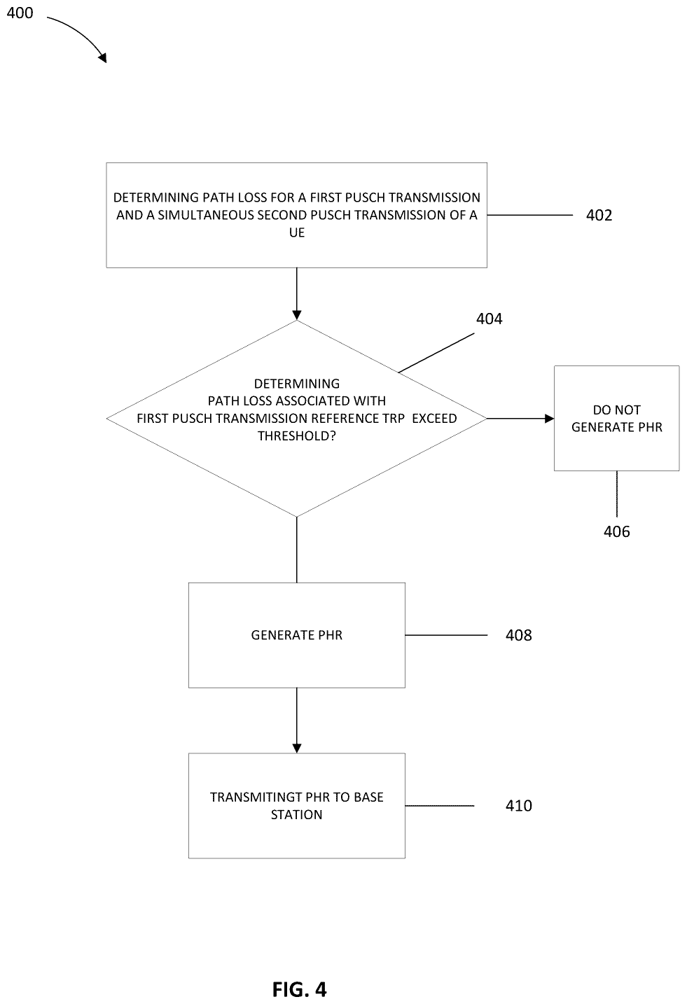

FIG. 4 is a process flow 400 for triggering a PHR generation, according to one or more embodiments. A UE (e.g., UE 106) can be simultaneously transmitting a PUSCH transmission to a first TRP (e.g., TRP 102) through a first antenna panel (e.g., first antenna 108) and a second PUSCH transmission to a second TRP (e.g., TRP 104) through a second antenna panel (e.g., second antenna panel 110). The base station can designate the first TRP as the reference TRP for powerhead purposes through an RRC configuration. At 402, the UE can be determining the path loss change for the first TRP (e.g., reference TRP).

At 404, the UE can be determining whether the path loss change associated with the first TRP (e.g., to the reference TRP) exceeds a threshold. In some instances, this threshold can be the phr-TX-PowerFactorChange parameter. For example, consider a situation in which the threshold can be 3 dB. If the path loss change for the first TRP is 4 db (e.g., +4 dB or |−4 dB|) or higher, the UE can be triggered to generate a PHR regardless of a path loss change at for the second TRP. If, however, the absolute value of the path loss change for first TRP is 3 db (e.g., +3 dB or |−3 dB|) or lower, the UE does not generate a PHR regardless of the path loss change for the second TRP.

If the path loss change associated with the first TRP does not exceed the threshold, the UE does not generate a PHR at 406. If, however, the path loss change associated with either of the first TRP does exceed the threshold, the UE does generate a PHR at 408. At 410, the UE can be transmitting the PHR to the base station.

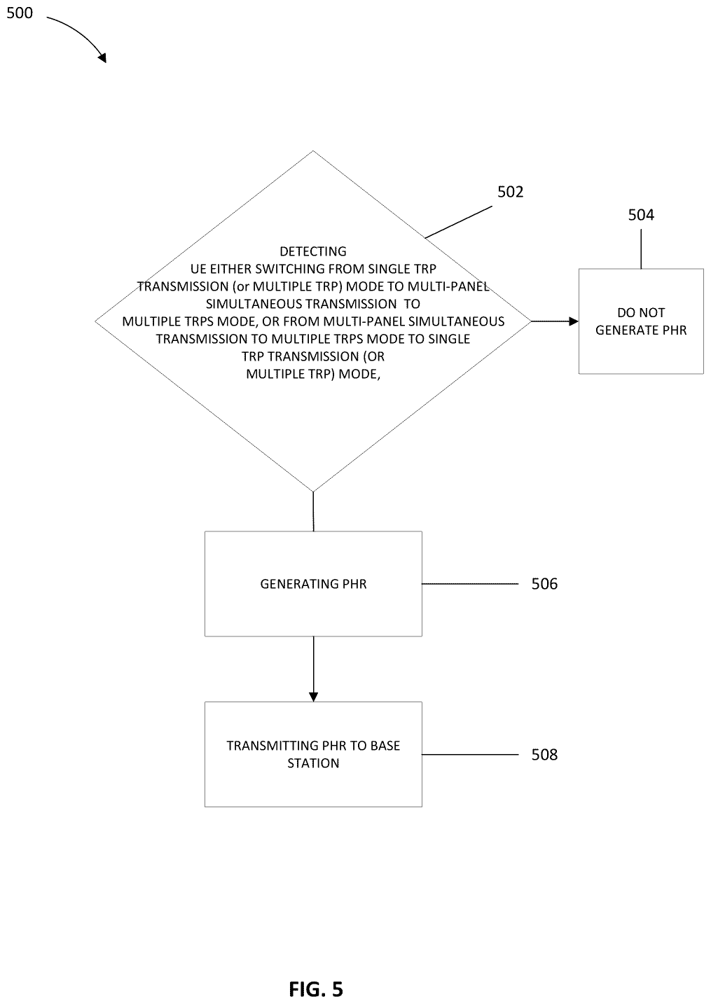

FIG. 5 is a process flow 500 for triggering a PHR generation, according to one or more embodiments. At 502, a UE can be detecting either switching from a single TRP (or a multiple TRP time domain-based) transmission to a multi-panel simultaneous transmission to multiple TRPs, or switching from multi-panel simultaneous transmission to multiple TRPs to a single TRP (or a multiple TRP time domain-based) transmission. A multi-panel simultaneous transmission to multiple TRPs can be a transmission technique in which the UE simultaneously transmits multiple UL transmissions via the frequency domain through respective UE antenna panels. Each UL transmission can be transmitted to a respective TRP on one or more base stations. The base station can configure the UE to switch from a single TRP (or a multiple TRP time domain-based) transmission to a multi-panel simultaneous transmission to multiple TRPs or vice versa.

If the UE does not switch from a single TRP (or a multiple TRP time domain-based) transmission to a multi-panel simultaneous transmission to multiple TRPs or vice versa, the UE does not generate a PHR at 504. If, however, the UE does switch from a single TRP (or a multiple TRP time domain-based) transmission to a multi-panel simultaneous transmission to multiple TRPs or vice versa, the UE does not generate a PHR at 506. At 508, the UE can be transmitting the PHR to the base station.

Embodiments herein are further directed to a methodology for a UE to determine whether a PHR for a cell is based on an actual transmission (actual PHR) or a reference format (virtual PHR) based on the higher layer signaling of configured grant and periodic/semi-persistent sounding reference signal transmissions and downlink control information. (3GPP TS 38.213 V17.20.0 (2022-06).

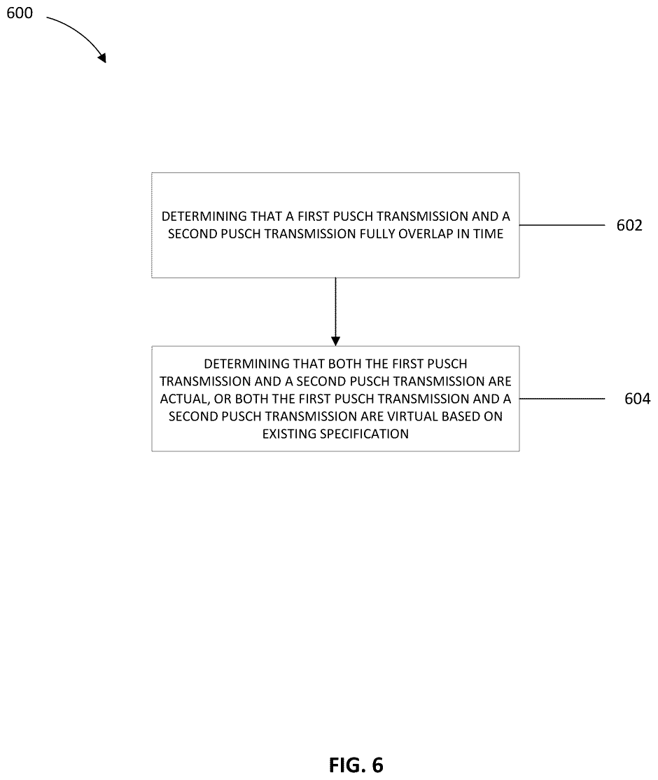

FIG. 6 is a process flow 600 for determining whether a PHR is an actual PHR or a virtual PHR, according to one or more embodiments. FIG. 6 applies to a situation in which a UE is simultaneously transmitting a first PUSCH transmission and a second PUSCH transmission (e.g., PUSCH+PUSCH) based on a single DCI. At 602, the UE can be determining that the first PUSCH transmission and the second PUSCH transmission both fully overlap in time. At 604, the UE can be determining that both the first PUSCH transmission and the second PUSCH transmission are actual, or the UE determines that both the first PUSCH transmission and the second PUSCH transmission are virtual.

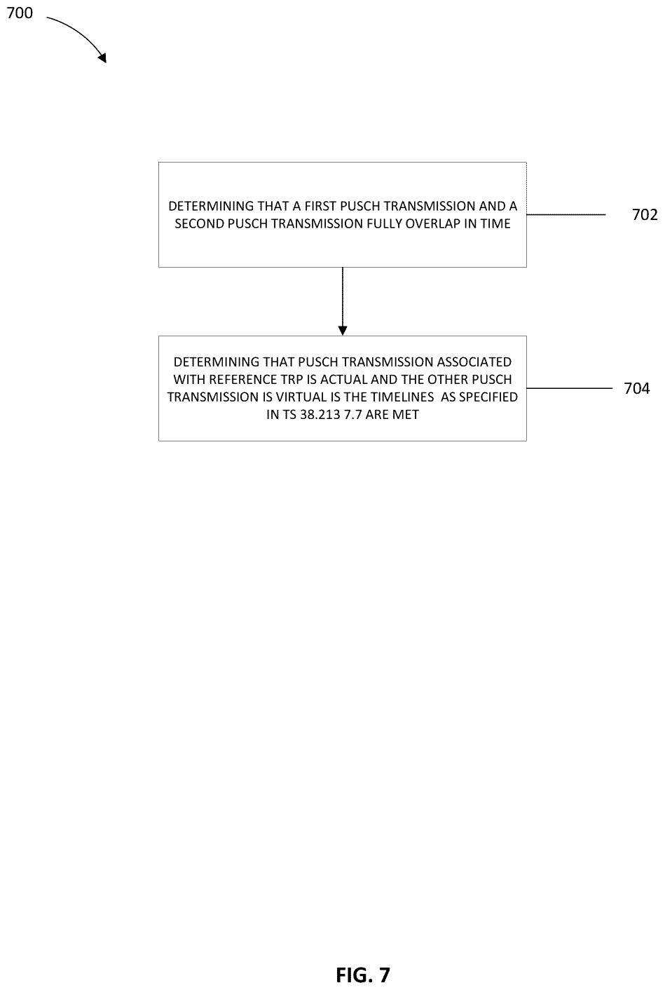

FIG. 7 is a process flow 700 for determining whether a PHR is an actual PHR or a virtual PHR, according to one or more embodiments. FIG. 7 applies to a situation in which a UE is simultaneously transmitting a first PUSCH transmission and a second PUSCH transmission (e.g., PUSCH+PUSCH) based on a single DCI. FIG. 7 further applies to a situation in which one TRP has been designated a reference TRP. At 702, the UE can be determining that the first PUSCH transmission and the second PUSCH transmission both fully overlap in time. At 704, the UE can be determining that the first or second PUSCH transmission associated with the reference TRP is actual and the other of the first and second PUSCH transmissions is virtual, provided that the timelines as specified in (3GPP TS 38.213 V17.20.0 (2022-06) are met.

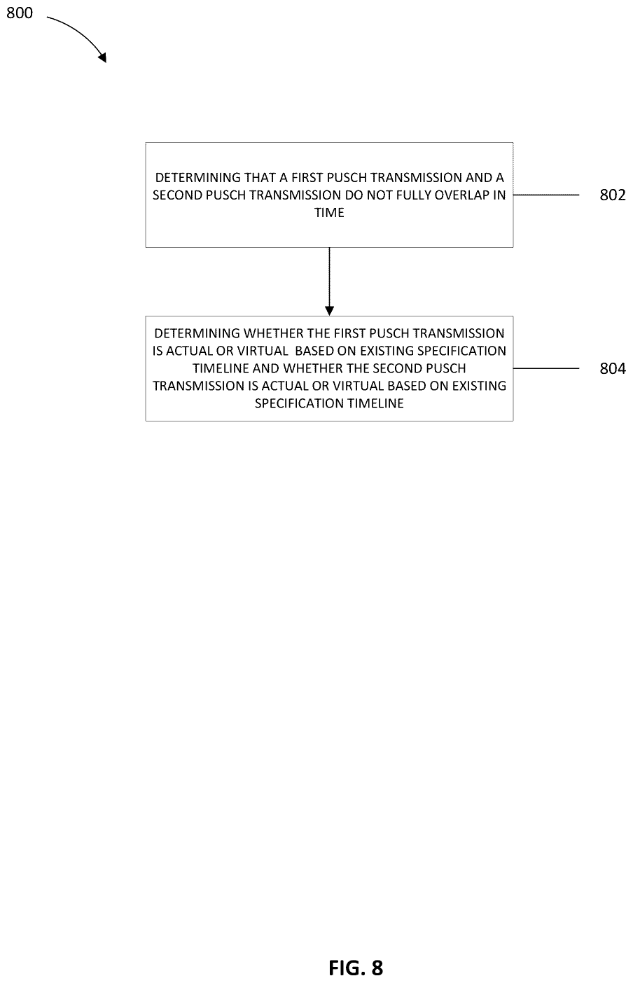

FIG. 8 is a process flow 800 for determining whether a PHR is an actual PHR or a virtual PHR, according to one or more embodiments. FIG. 8 applies to a situation in which a UE is simultaneously transmitting a first PUSCH transmission and a second PUSCH transmission (e.g., PUSCH+PUSCH) to multiple TRPs. At 802, the UE can be determining that the first PUSCH transmission and the second PUSCH transmission do not fully overlap in time. At 804, the UE can be determining whether the first PUSCH transmission is actual or virtual based on the existing specification timeline. The UE can also determine whether the second PUSCH transmission is actual or virtual based on the existing specification timeline.

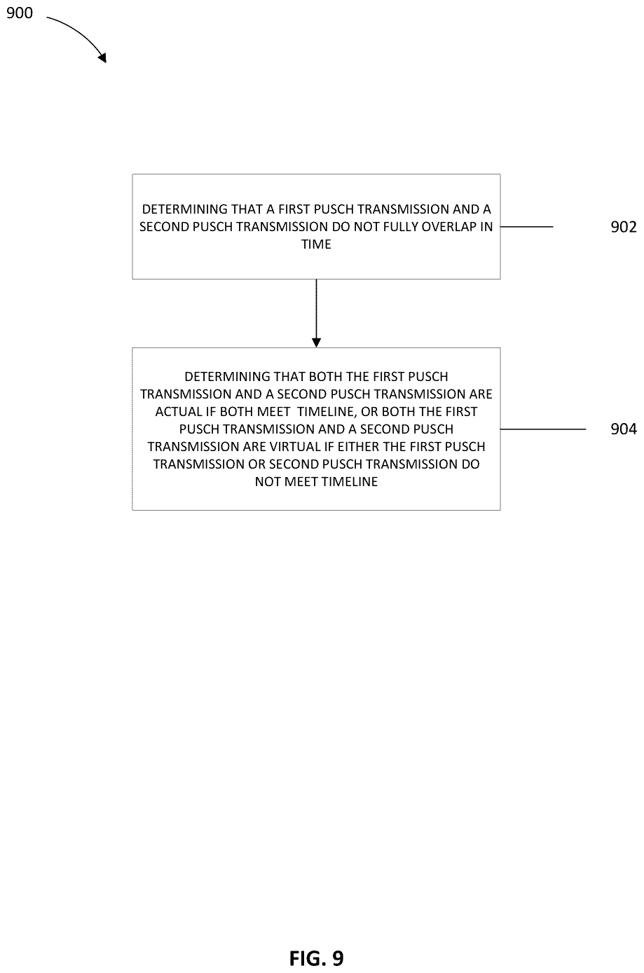

FIG. 9 is a process flow 900 for determining whether a PHR is an actual PHR or a virtual PHR, according to one or more embodiments. FIG. 9 applies to a situation in which a UE is simultaneously transmitting a first PUSCH transmission and a second PUSCH transmission (e.g., PUSCH+PUSCH) to multiple TRPs. At 902, the UE can be determining that the first PUSCH transmission and the second PUSCH transmission do not fully overlap in time. At 904, the UE can be determining that both the first PUSCH transmission and the second PUSCH transmission are actual if both meet the existing specification timelines. Or the UE can determine that both the first PUSCH transmission and the second PUSCH transmission are virtual if either of the first PUSCH transmission and the second PUSCH transmission do not meet the existing specification timeline.

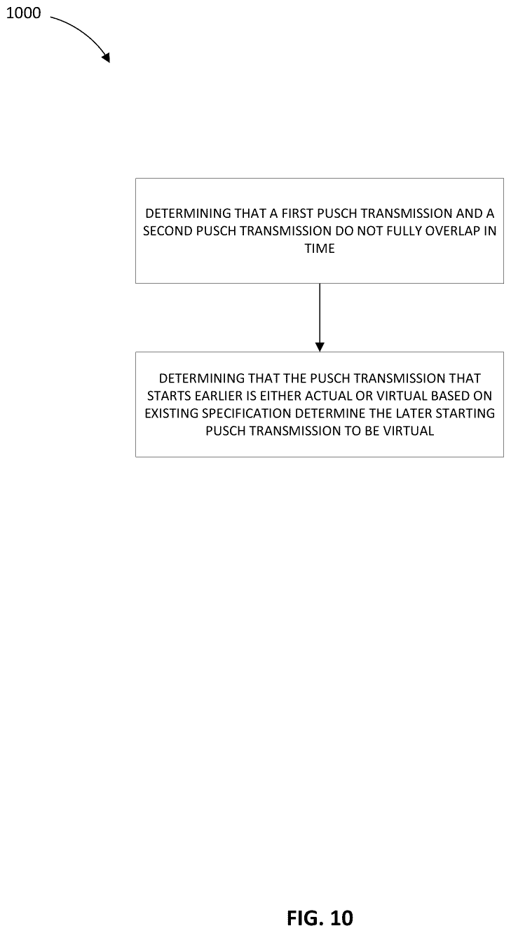

FIG. 10 is a process flow 1000 for determining whether a PHR is an actual PHR or a virtual PHR, according to one or more embodiments. FIG. 10 applies to a situation in which a UE is simultaneously transmitting a first PUSCH transmission and a second PUSCH transmission (e.g., PUSCH+PUSCH) to multiple TRPs. At 1002, the UE can be determining that the first PUSCH transmission and the second PUSCH transmission do not fully overlap in time. At 1004, the UE can be determining that the PUSCH transmission (either first PUSCH transmission or second PUSCH transmission) that starts earlier is either actual or virtual based on existing specification. Determine that the later starting PUSCH transmission to be virtual.

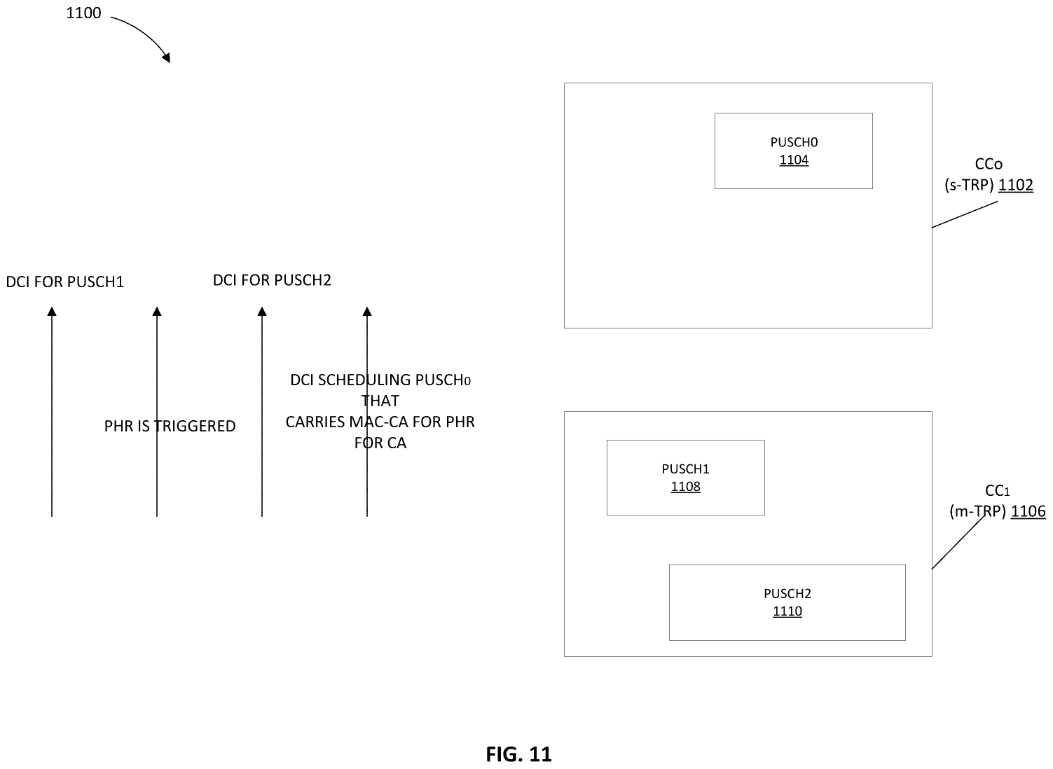

FIG. 11 is an illustration 1100 of a determination of whether a PHR is an actual PHR or a virtual PHR, according to one or more embodiments. As illustrated, a first component carrier (CC₀) 1102 includes a first PUSCH transmission (PUSCH0) and is being transmitted to a single TRP (s-TRP). A second component carrier 1106 is carrying a second PUSCH transmission (PUSCH1) 1108 and a third PUSCH transmission (PUSCH2) 1110 to respective TRPs (m-TRP). As illustrated, the second PUSCH transmission 1108 starts earlier in time than the third PUSCH transmission 1110. In this example, the PHR for the first PUSCH transmission 1104 is computed based on an actual transmission based on the first PUSCH transmission 1104 being fully overlapped in the time domain with the third PUSCH transmission 1110 and both transmissions meeting the existing specification timelines. The PHR for the second PUSCH transmission 1108 is computed based on a virtual transmission based on the second PUSCH transmission 1108 not fully overlapping with the other transmissions and the first PUSCH transmission 1104 being computing based on actual transmission. If the process described with relation to FIG. 8 is selected, the third PUSCH transmission 1110 is computed based on an actual transmission from meeting the existing specification timeline. If the processes described with relation to FIG. 10 or FIG. 11 are selected, the PHR for the third PUSCH transmission 1110 is computed based on virtual transmission.

Embodiments herein are further directed towards power headroom calculation. Power headroom calculation is described by 3GPP TS 38.213 V17.20.0 (2022-06).

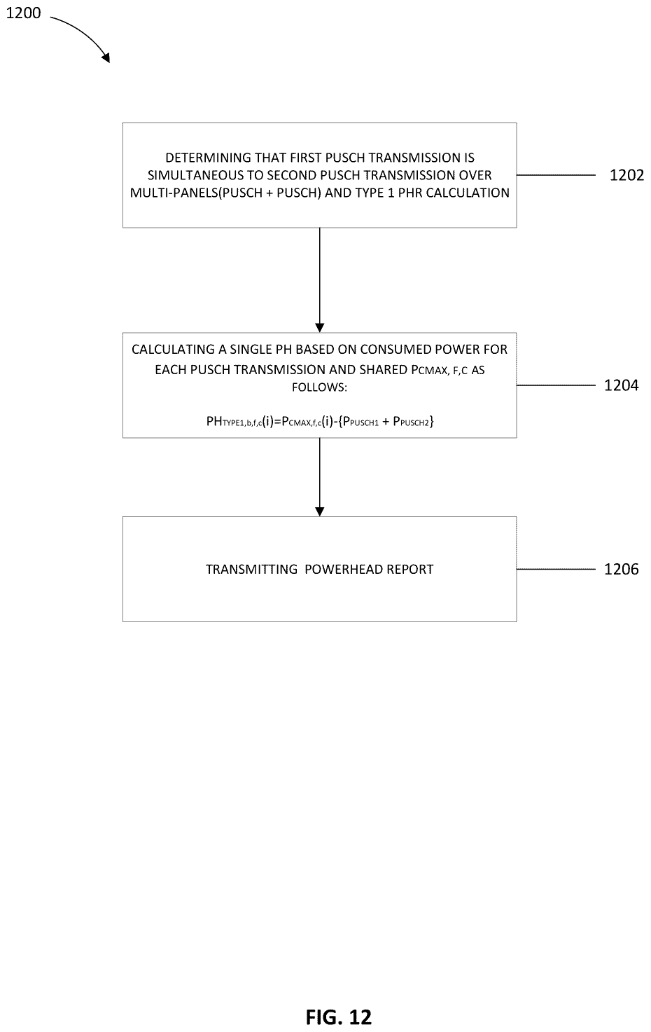

FIG. 12 is a process flow 1200 for powerhead calculation, according to one or more embodiments. At 1202, the UE can be determining that the first PUSCH transmission and the second PUSCH transmission are simultaneously transmitted over multi-panels and to use a type 1 PHR calculation. Furthermore, the UE can determine to define total radiated power and Equivalent Isotropically Radiated Power (EIRP) across the panels. At 1204, the UE can be calculating a single PH based on consumed power for each PUSCH transmission and shared P_{CMax,f,c} using the following equation;

PH_{Type1,b,f,c}(i)=P_{CMax,f,c}(i)−{P_{PUSCH1}+P_{PUSCH2}}

At 1206, the UE can transmit the PHR to the base station.

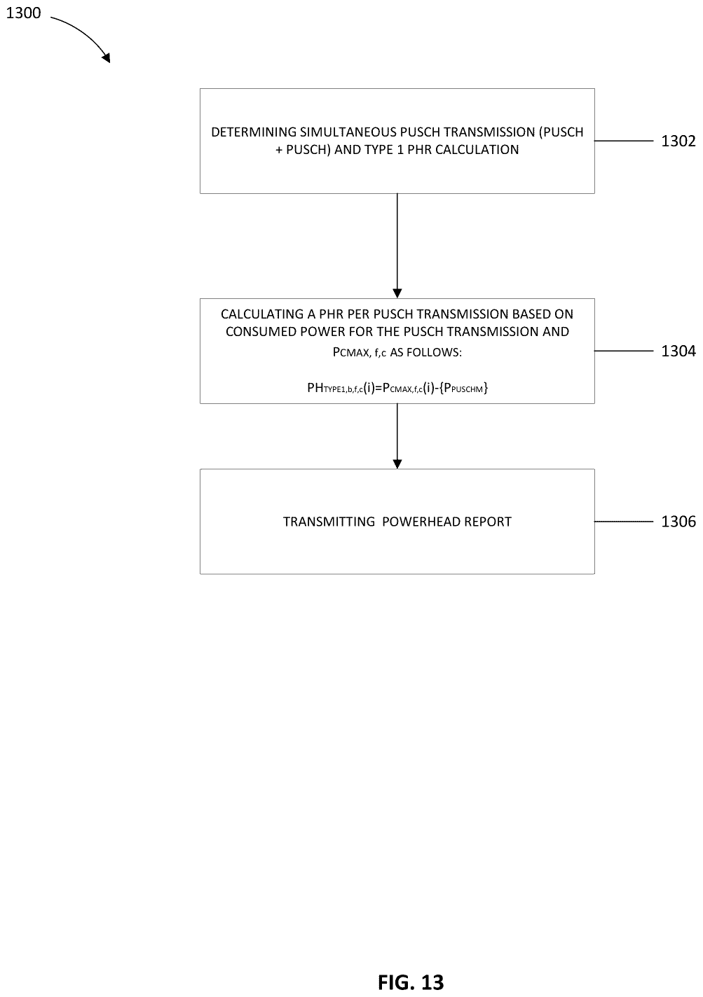

FIG. 13 is a process flow 1300 for powerhead calculation, according to one or more embodiments. At 1302, the UE can be determining that the first PUSCH transmission and the second PUSCH transmission are simultaneously transmitted over multi-panels and to use a type 1 PHR calculation. Furthermore, the UE can determine to define total radiated power and Equivalent Isotropically Radiated Power (EIRP) across the panels. At 1304, the UE can be calculating a respective PH based on consumed power for the respective PUSCH transmission and shared P_{CMax,f,c} using the following equation;

PH_{Type1,b,f,c}(i)=P_{CMax,f,c}(i)−{P_{PUSCHM}}

At 1306, the UE can be transmitting the PHR to the base station.

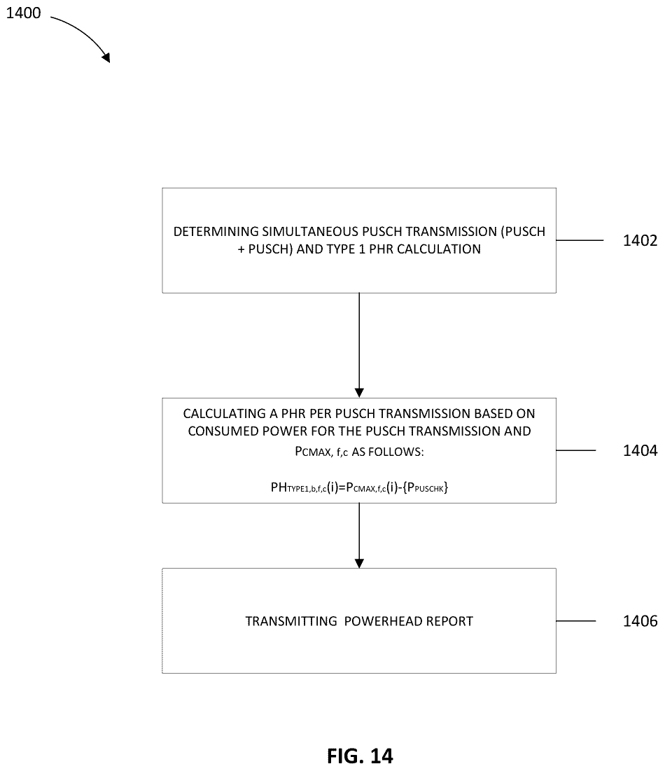

FIG. 14 is a process flow for powerhead calculation, according to one or more embodiments. At 1402, the UE can be determining that the first PUSCH transmission and the second PUSCH transmission are simultaneously transmitted over multi-panels and to use a type 1 PHR calculation. Furthermore, the UE can determine to define total radiated power and Equivalent Isotropically Radiated Power (EIRP) per panel. At 1404, the UE can be calculating a respective PH based on consumed power for the respective PUSCH transmission and shared P_{CMax,f,c} using the following equation;

PH_{Type1,b,f,c}(i)=P_{CMax,f,c}(i)−{P_{PUSCHM}}

At 1406, the UE can be transmitting the PHR to the base station.

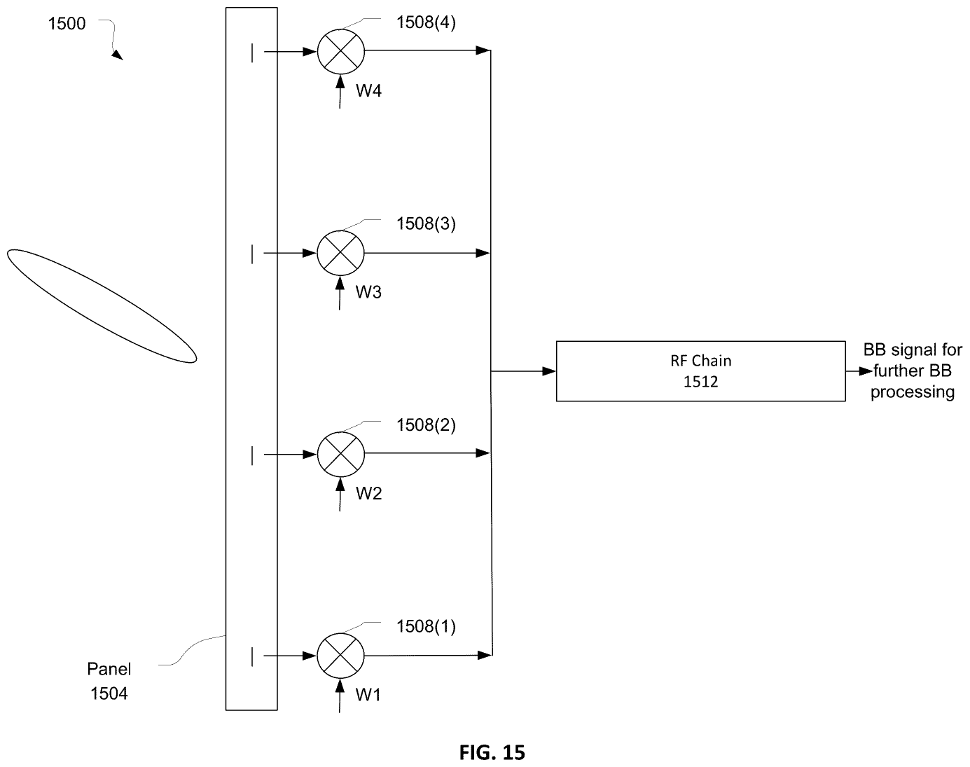

FIG. 15 illustrates receive components 1500 of the UE 1506, in accordance with some embodiments. The receive components 1500 may include an antenna panel 1504 that includes a number of antenna elements. The panel 1504 is shown with four antenna elements, but other embodiments may include other numbers

The antenna panel 1504 may be coupled to analog beamforming (BF) components that include a number of phase shifters 1508(1)-1508(4). The phase shifters 1508(1)-1508(4) may be coupled with a radio-frequency (RF) chain 1512. The RF chain 1512 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1508(1)-1508(4) to provide a receive beam at the antenna panel 1504. These BF weights may be determined based on the channel-based beamforming.

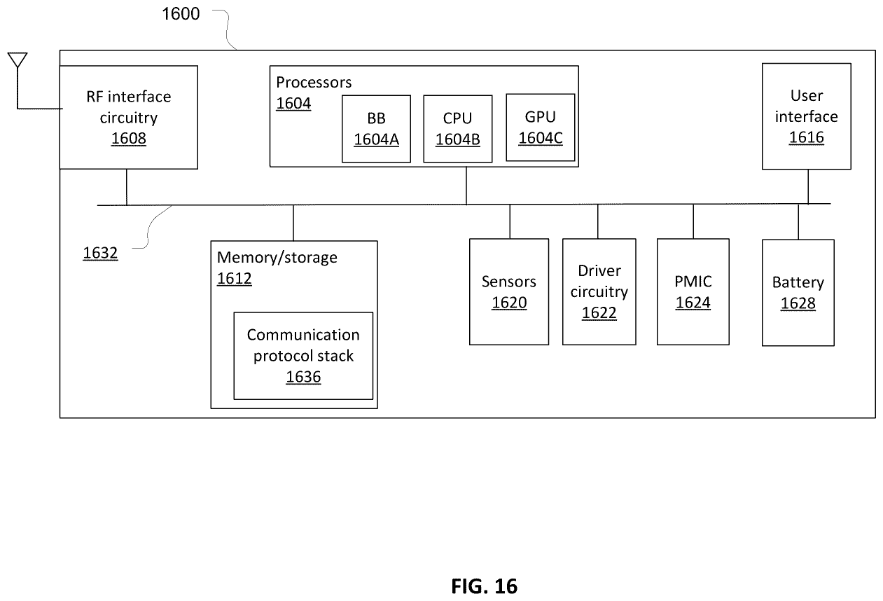

FIG. 16 illustrates a UE 1600, in accordance with some embodiments. The UE 1600 may be similar to and substantially interchangeable with UE 1506 of FIG. 15.

Similar to that described above with respect to UE 1600, the UE 1600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1600 may include processors 1604, RF interface circuitry 1608, memory/storage 1612, user interface 1616, sensors 1620, driver circuitry 1622, power management integrated circuit (PMIC) 1624, and battery 1628. The components of the UE 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the UE 1600. However, some of the components shown may be omitted, additional components may be present, and different arrangements of the components shown may occur in other implementations.

The components of the UE 1600 may be coupled with various other components over one or more interconnects 1632, which may represent any type of interface, input/output, bus (local, system, or expansion), transmission line, trace, optical connection, etc. that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform operations as described herein.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1604A may also access group information 1624 from memory/storage 1612 to determine search space groups in which a number of repetitions of a PDCCH may be transmitted.

The memory/storage 1612 may include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and a radio frequency front module (RFEM) that allows the UE 1600 to communicate with other devices over a radio access network. The RF interface circuitry 1608 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1624 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1624.

In various embodiments, the RF interface circuitry 1608 may be configured to transmit/receive signals in a manner compatible with NR access technologies.

The antenna 1624 may include a number of antenna elements that each convert electrical signals into radio waves to travel through the air and to convert received radio waves into electrical signals. The antenna elements may be arranged into one or more antenna panels. The antenna 1624 may have antenna panels that are omnidirectional, directional, or a combination thereof to enable beamforming and multiple input, multiple output communications. The antenna 1624 may include microstrip antennas, printed antennas fabricated on the surface of one or more printed circuit boards, patch antennas, phased array antennas, etc. The antenna 1624 may have one or more panels designed for specific frequency bands including bands in FR1 or FR2.

The user interface circuitry 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within, or connected to, the UE 1600. For example, driver circuitry 1622 may include a display driver to control and allow access to a display device, a touchscreen driver to control and allow access to a touchscreen interface, sensor drivers to obtain sensor readings of sensor circuitry 1620 and control and allow access to sensor circuitry 1620, drivers to obtain actuator positions of electro-mechanic components or control and allow access to the electro-mechanic components, a camera driver to control and allow access to an embedded image capture device, audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1600 may power down for brief intervals of time and thus save power. If there is no data traffic activity for an extended period of time, then the UE 1600 may transition off to an RRC_Idle state, where it disconnects from the network and does not perform operations such as channel quality feedback, handover, etc. The UE 1600 goes into a very low power state and it performs paging where again it periodically wakes up to listen to the network and then powers down again. The UE 1600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1628 may power the UE 1600, although in some examples the UE 1600 may be mounted deployed in a fixed location, and may have a power supply coupled to an electrical grid. The battery 1628 may be a lithium ion battery, a metal-air battery, such as a zinc-air battery, an aluminum-air battery, a lithium-air battery, and the like. In some implementations, such as in vehicle-based applications, the battery 1628 may be a typical lead-acid automotive battery.

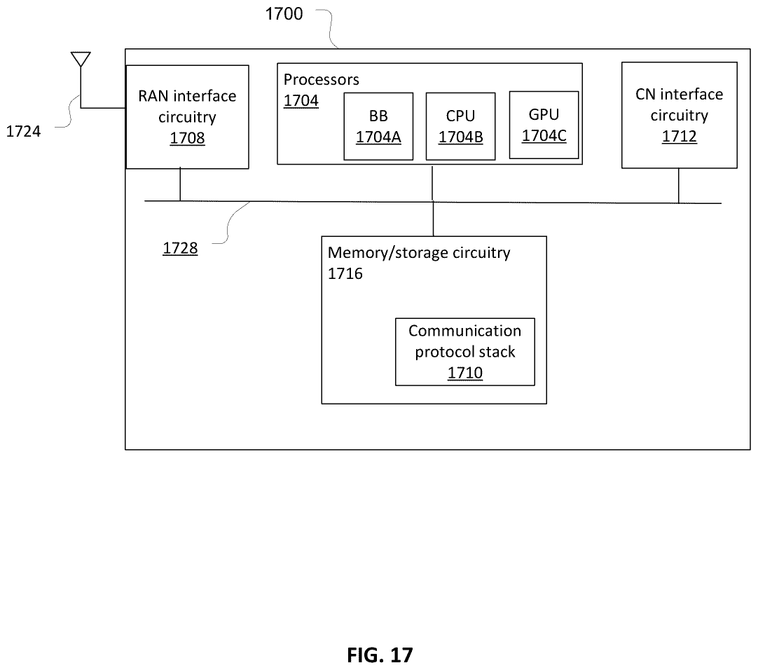

FIG. 17 illustrates a gNB 1700, in accordance with some embodiments. The gNB node 1700 may be similar to and substantially interchangeable with the base stations 174, 176 of FIG. 1.

The gNB 1700 may include processors 1704, RF interface circuitry 1708, core network (CN) interface circuitry 1712, and memory/storage circuitry 1716.

The components of the gNB 1700 may be coupled with various other components over one or more interconnects 1728.

The processors 1704, RF interface circuitry 1708, memory/storage circuitry 1716 (including communication protocol stack 1710), antenna 1724, and interconnects 1728 may be similar to like-named elements shown and described with respect to FIG. 15.

The CN interface circuitry 1712 may provide connectivity to a core network, for example, a 4th Generation Core network (5GC) using a 4GC-compatible network interface protocol such as carrier Ethernet protocols, or some other suitable protocol. Network connectivity may be provided to/from the gNB 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a user equipment (UE), comprising a processor; a first antenna panel; a second antenna panel; and a computer-readable medium including instructions that, when executed by the processor, cause the processor to perform operations including: determining a first path loss change of a first physical uplink shared channel (PUSCH) transmission from the first antenna panel to a first transmission and reception point (TRP); determining a second path loss change of a second PUSCH transmission from the second antenna panel to a second TRP, the second PUSCH transmission being simultaneous with the first PUSCH transmission; determining that a powerhead report (PHR) is to be generated based on the first path loss change and the second path loss change; and generating the PHR based on the determination.

Example 2 includes the UE of example 1, wherein generating the PHR comprise: determining whether a first absolute value of the first path loss change is greater than a threshold; determining whether a second absolute value of the second path loss change is greater than the threshold; and determining to generate the PHR based on the absolute value of the first path loss change and the absolute value of the second path loss change being respectively greater than the threshold.

Example 3 includes the UE of example 2, wherein the threshold includes a phr-TX-PowerFactorChange parameter.

Example 4 includes the UE of example 1, wherein generating the PHR includes determining a sum of a first absolute value of the first path loss change and a second absolute value of the second path loss change is greater than a threshold; and determining to generate the PHR based on a sum of the absolute value of the first path loss change and the absolute value of the second path loss change being greater than the threshold.

Example 5 includes the UE of example 1, wherein generating the PHR includes determining whether a first absolute value of the first path loss change is greater than a threshold; determining whether a second absolute value of the second path loss change is greater than the threshold; and determining to generate the PHR based on either the first absolute value or the second absolute value being greater than the threshold.

Example 6 includes the UE of example 1, wherein generating the PHR includes determining whether an absolute value of the first path loss change is greater than a threshold, wherein the first path loss change is associated with a reference TRP; and determining to generate the PHR based on the absolute value of the first path loss change being greater than the threshold.

Example 7 includes the UE of example 1, wherein the instructions that, when executed by the processor, further cause the processor to detect a switch from either a single TRP mode to a multi-panel simultaneous transmission mode, or a switch from the multi-panel simultaneous transmission mode to the single TRP mode.

Example 8 includes the UE of example 1, wherein the instructions that, when executed by the processor, further cause the processor to determine whether the PHR is an actual PHR or a virtual PHR based on an overlapping of the first PUSCH transmission and the second PUSCH transmission fully overlap in time domain and a timeline being met.

Example 9 includes the UE of any of examples 1-8, wherein the instructions that, when executed by the processor, further cause the processor to determine whether the PHR is an actual PHR or a virtual PHR based on the first PUSCH transmission starting earlier than the second PUSCH transmission and a timeline being met.

Example 10 includes the UE of example 1, wherein the instructions that, when executed by the processor, further cause the processor to calculate a powerhead based on consumed power of the first PUSCH transmission and the second PUSCH transmission, wherein a total radiated power and the equivalent isotropically radiated power (EIRP) are defined across all the first panel and the second panel.

Example 11 includes the UE of example 1, wherein the instructions that, when executed by the processor, further cause the processor to calculate a first powerhead for the first PUSCH transmission and a second powerhead for the second PUSCH transmission, wherein a total radiated power and the equivalent isotropically radiated power (EIRP) are defined per the first panel and per the second panel.

Example 12 includes a computer-readable medium having stored thereon a sequence of instructions which, when executed, causes a processor to perform operations including determining a first path loss change of a first physical uplink shared channel (PUSCH) transmission from the first antenna panel to a first transmission and reception point (TRP); determining a second path loss change of a second PUSCH transmission from the second antenna panel to a second TRP, the second PUSCH transmission being simultaneous with the first PUSCH transmission; determining that a powerhead report (PHR) is to be generated based on the first path loss change and the second path loss change; and generating the PHR based on the determination.

Example 13 includes the computer-readable medium of example 12, wherein generating the PHR includes determining whether an absolute value of the first path loss change is greater than a threshold; determining whether an absolute value of the second path loss change is greater than the threshold; and determining to generate the PHR based on the absolute value of the first path loss change and the absolute value of the second path loss change being respectively greater than the threshold.

Example 14 includes the computer-readable medium of example 12, wherein the first PUSCH transmission and the second PUSCH transmission fully overlap in a time domain, and wherein the instructions that, when executed by the processor, further cause the processor to determine, based on a timeline, that either both the first PUSCH transmission and the second PUSCH transmission are a respective actual PUSCH transmission, or both the first PUSCH transmission and the second PUSCH transmission are a respective virtual PUSCH transmission.

Example 15 includes the computer-readable medium of example 12, wherein the first PUSCH transmission and the second PUSCH transmission fully overlap in a time domain, wherein the first TRP is a reference TRP, and wherein the instructions that, when executed by the processor, further cause the processor to determine, based on a timeline and the first TRP being the reference TRP, the first PUSCH transmission is an actual PUSCH transmission and the second PUSCH transmission is a virtual PUSCH transmission.

Example 16 includes the computer-readable medium of example 12, wherein the first PUSCH transmission and the second PUSCH transmission do not fully overlap in a time domain, and wherein the instructions that, when executed by the processor, further cause the processor to determine that the first PUSCH transmission is an actual PUSCH transmission and the second PUSCH transmission is an actual PUSCH transmission based on the first PUSCH transmission meeting a first timeline and the second PUSCH transmission meeting a second timeline.

Example 17 includes the computer-readable medium of example 12, wherein the first PUSCH transmission and the second PUSCH transmission do not fully overlap in a time domain, and wherein the instructions that, when executed by the processor, further cause the processor to determine that the first PUSCH transmission is a virtual PUSCH transmission and the second PUSCH transmission is an virtual PUSCH transmission based on the first PUSCH transmission not meeting a first timeline or the second PUSCH transmission not meeting a second timeline.

Example 18 includes the computer-readable medium of example 12, wherein the first PUSCH transmission and the second PUSCH transmission do not fully overlap in a time domain, wherein the first PUSCH transmission starts before the second PUSCH transmission, and wherein the instructions that, when executed by the processor, further cause the processor to determine the first PUSCH transmission is an actual PUSCH transmission and the second PUSCH transmission is a virtual PUSCH transmission.

Example 19 includes a network, comprising a processor; and a computer-readable medium including instructions that, when executed by the processor, cause the processor to perform operations comprising receiving a power headroom report (PHR) from a user equipment (UE), the PHR associated with a first physical uplink shared channel (PUSCH) transmission of the UE to a first transmission and reception point (TRP) of the network and a second PUSCH transmission of the UE to a second TRP of the network; and adjusting a functionality of the UE based on the PHR.

Example 20 includes the network of example 19, wherein the instructions, when executed by the processor, further cause the processor to transmit a radio resource control (RRC) configured powerhead threshold to a UE; and receive the PHR based on the powerhead threshold.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A user equipment (UE), comprising:
a processor;
a first antenna panel;
a second antenna panel; and
a computer-readable medium including instructions that, when executed by the processor, cause the processor to:
determine a first path loss change of a first physical uplink shared channel (PUSCH) transmission from the first antenna panel to a first transmission and reception point (TRP);
determine a second path loss change of a second PUSCH transmission from the second antenna panel to a second TRP, the second PUSCH transmission being simultaneous with the first PUSCH transmission;
determine that a power headroom report (PHR) is to be generated based on the first path loss change and the second path loss change; and
generate the PHR based on the determination.

2. The UE of claim 1, wherein generating the PHR includes:
determining whether a first absolute value of the first path loss change is greater than a threshold;
determining whether a second absolute value of the second path loss change is greater than the threshold; and
determining to generate the PHR based on the absolute value of the first path loss change and the absolute value of the second path loss change being respectively greater than the threshold.

3. The UE of claim 2, wherein the threshold includes a phr-TX-PowerFactorChange parameter.

4. The UE of claim 1, wherein determining that the PHR is to be generated includes:
determining a sum of a first absolute value of the first path loss change and a second absolute value of the second path loss change is greater than a threshold; and
determining to generate the PHR based on a sum of the absolute value of the first path loss change and the absolute value of the second path loss change being greater than the threshold.

5. The UE of claim 1, wherein determining that the PHR is to be generated includes:
determining whether a first absolute value of the first path loss change is greater than a threshold;
determining whether a second absolute value of the second path loss change is greater than the threshold; and
determining to generate the PHR based on either the first absolute value or the second absolute value being greater than the threshold.

6. The UE of claim 1, wherein determining that the PHR is to be generated:
determining whether an absolute value of the first path loss change is greater than a threshold, wherein the first path loss change is associated with a reference TRP; and
determining to generate the PHR based on the absolute value of the first path loss change being greater than the threshold.

7. The UE of claim 1, wherein the instructions that, when executed by the processor, further cause the processor to detect a switch from either a single TRP mode to a multi-panel simultaneous transmission mode, or a switch from the multi-panel simultaneous transmission mode to the single TRP mode, wherein the determining that the PHR is to be generated is further based on the detection.

8. The UE of claim 1, wherein the instructions that, when executed by the processor, further cause the processor to determine whether the PHR is an actual PHR or a virtual PHR based on the first PUSCH transmission and the second PUSCH transmission fully overlapping in a time domain.

9. The UE of claim 1, wherein the instructions that, when executed by the processor, further cause the processor to determine whether the PHR is an actual PHR or a virtual PHR based on the first PUSCH transmission starting earlier than the second PUSCH transmission.

10. The UE of claim 1, wherein the instructions that, when executed by the processor, further cause the processor to calculate a power headroom based on consumed power of the first PUSCH transmission and the second PUSCH transmission, wherein a total radiated power and an equivalent isotropically radiated power (EIRP) are defined across both of the first panel and the second panel.

11. The UE of claim 1, wherein the instructions that, when executed by the processor, further cause the processor to calculate a first power headroom for the first PUSCH transmission and a second power headroom for the second PUSCH transmission, wherein a total radiated power and an equivalent isotropically radiated power (EIRP) are defined per the first panel and per the second panel.

12. A non-transitory, computer-readable medium having stored thereon a sequence of instructions which, when executed, causes a processor to perform operations comprising:
determining a first path loss change of a first physical uplink shared channel (PUSCH) transmission from a first antenna panel to a first transmission and reception point (TRP);
determining a second path loss change of a second PUSCH transmission from a second antenna panel to a second TRP, the second PUSCH transmission being simultaneous with the first PUSCH transmission;
determining that a power headroom report (PHR) is to be generated based on the first path loss change and the second path loss change; and
generating the PHR based on the determination.

13. The non-transitory, computer-readable medium of claim 12, wherein generating the PHR includes:
determining whether an absolute value of the first path loss change is greater than a threshold;
determining whether an absolute value of the second path loss change is greater than the threshold; and
determining to generate the PHR based on the absolute value of the first path loss change and the absolute value of the second path loss change being respectively greater than the threshold.

14. The non-transitory, computer-readable medium of claim 12, wherein the first PUSCH transmission and the second PUSCH transmission fully overlap in a time domain, and wherein the instructions that, when executed by the processor, further cause the processor to determine, based on a timeline, that either the first PUSCH transmission is an actual PUSCH transmission and the second PUSCH transmission is an actual PUSCH transmission, or that the first PUSCH transmission is virtual PUSCH transmission and the second PUSCH transmission is a virtual PUSCH transmission.

15. The non-transitory, computer-readable medium of claim 12, wherein the first PUSCH transmission and the second PUSCH transmission fully overlap in a time domain, wherein the first TRP is a reference TRP, and wherein the instructions that, when executed by the processor, further cause the processor to determine, based on a timeline and the first TRP being the reference TRP, that the first PUSCH transmission is an actual PUSCH transmission and the second PUSCH transmission is a virtual PUSCH transmission.

16. The non-transitory, computer-readable medium of claim 12, wherein the first PUSCH transmission and the second PUSCH transmission do not fully overlap in a time domain, and wherein the instructions that, when executed by the processor, further cause the processor to determine that the first PUSCH transmission is an actual PUSCH transmission and the second PUSCH transmission is an actual PUSCH transmission based on the first PUSCH transmission meeting a first timeline and the second PUSCH transmission meeting a second timeline.

17. The non-transitory, computer-readable medium of claim 12, wherein the first PUSCH transmission and the second PUSCH transmission do not fully overlap in a time domain, and wherein the instructions that, when executed by the processor, further cause the processor to determine that the first PUSCH transmission is a virtual PUSCH transmission and the second PUSCH transmission is an virtual PUSCH transmission based on the first PUSCH transmission not meeting a first timeline or the second PUSCH transmission not meeting a second timeline.

18. The non-transitory, computer-readable medium of claim 12, wherein the first PUSCH transmission and the second PUSCH transmission do not fully overlap in a time domain, wherein the first PUSCH transmission starts before the second PUSCH transmission, and wherein the instructions that, when executed by the processor, further cause the processor to determine the first PUSCH transmission is an actual PUSCH transmission and the second PUSCH transmission is a virtual PUSCH transmission.

19. A network node, comprising:
a processor; and
a computer-readable medium including instructions that, when executed by the processor, cause the processor to:
receive a power headroom report (PHR) from a user equipment (UE), the PHR associated with a first physical uplink shared channel (PUSCH) transmission of the UE to a first transmission and reception point (TRP) of the network and a second PUSCH transmission of the UE to a second TRP of the network; and
adjust a functionality of the UE based on the PHR.

20. The network node of claim 19, wherein the instructions, when executed by the processor, further cause the processor to:
transmit a radio resource control (RRC) configured threshold to a UE; and
receive the PHR based on the threshold.
